(19) United States
(12) Patent Application Publication
(10) Pub. No.: US 2022/0401949 A1
(43) Pub. Date: Dec. 22, 2022

(54) CHANNEL DEVICE

(71) Applicant: KYOCERA Corporation, Kyoto-shi, Kyoto (JP)

(72) Inventor: Takeshi IKEMOTO, Suita-shi, Osaka (JP)

(21) Appl. No.: 17/779,531

(22) PCT Filed: Nov. 26, 2020
(86) PCT No.: PCT/JP2020/044002

§ 371 Date: May 24, 2022

(30) Foreign Application Priority Data
Nov. 27, 2019 (JP) 2019-214386

(51) Int. Cl. B01L 3/00

(52) U.S. Cl. CPC B01L 3/5027; B01L 2200/0684; B01L 2200/021

(57) ABSTRACT

An embodiment of a channel device (1) according to the present disclosure includes a channel (2) and a first space (3) and a second space (4) located in the channel (2). The channel (2) includes a side surface along a direction in which a liquid flows. The second space (4) is connected to the first space (3). An upper end of the second space (4) is located at a different height from an upper end of the first space (3). At least a part of the first space (3) is located between the side surface of the channel (2) and at least a part of an outer periphery of the second space (4).

### TECHNICAL FIELD

The present invention relates to a channel device.

### BACKGROUND ART

Patent Document 1 describes a microchannel device through which a liquid flows.

### CITATION LIST

### Patent Literature

Patent Document 1: JP 2015-166707 A

### SUMMARY

### Technical Problem

In a channel device, there is a need to reduce the risk of air bubbles being mixed in a liquid when the liquid is made to flow through a channel.

### Solution to Problem

An embodiment of a channel device according to the present invention includes a channel and a first space and a second space located in the channel. The channel includes a side surface along a direction in which a liquid flows. The second space is connected to the first space. An upper end of the second space is located at a different height from an upper end of the first space. At least a part of the first space is located between the side surface of the channel and at least a part of an outer periphery of the second space.

### Advantageous Effects of Invention

According to a channel device according to the present invention, a risk of air bubbles being mixed in a liquid when the liquid is made to flow through a channel can be reduced.

### BRIEF DESCRIPTION OF DRAWINGS

FIG. 1 is a top view of a channel device 1 according to an embodiment.

FIG. 2 is a top view of the channel device 1 according to the embodiment.

FIG. 3 is a cross-sectional view of the channel device 1 according to the embodiment.

FIG. 4 is a cross-sectional view of the channel device 1 according to the embodiment.

FIG. 5 is a cross-sectional view of the channel device 1 illustrated in FIGS. 2 and 3.

FIG. 6 is a cross-sectional view of the channel device 1 according to the embodiment.

FIG. 7 is a cross-sectional view of the channel device 1 according to the embodiment.

FIG. 8 is a cross-sectional view of the channel device 1 according to the embodiment.

FIG. 9 is a cross-sectional view of the channel device 1 according to the embodiment.

FIG. 10 is a cross-sectional view of the channel device 1 according to the embodiment.

FIG. 11 is a cross-sectional view of the channel device 1 according to the embodiment.

FIG. 12 is a cross-sectional view of the channel device 1 according to the embodiment.

FIG. 13 is a cross-sectional view of the channel device 1 according to the embodiment.

FIG. 14 is a cross-sectional view of the channel device 1 according to the embodiment.

FIG. 15 is a cross-sectional view of the channel device 1 according to the embodiment.

FIG. 16 is a top view of the channel device 1 according to the embodiment.

FIG. 17 is a top view of the channel device 1 according to the embodiment.

FIG. 18 is a top view of the channel device 1 according to the embodiment.

FIG. 19 is a top view of the channel device 1 according to the embodiment.

FIG. 20 is a perspective view of a channel device 1 according to another embodiment.

FIG. 21 is a cross-sectional view of the channel device 1 according to the other embodiment illustrated in FIG. 20.

FIG. 22 is a top view of a channel device 1 according to an embodiment.

FIG. 23 is a top view of a channel device 1 according to an embodiment.

FIG. 24 is a top view of a channel device 1 according to an embodiment.

FIG. 25 is a top view of a channel device 1 according to an embodiment.

### DESCRIPTION OF EMBODIMENTS

### First Embodiment

A channel device 1 according to the present disclosure will be described below with reference to the drawings. Note that in the present disclosure, for convenience, description will be made, wherein a direction of gravity or surface tension is referred to as a “downward direction”, and a direction opposite to the direction of gravity or surface tension is referred to as an “upward direction”. Further, in the present disclosure, description will be made, wherein a position where a liquid flowing into the channel device 1 reaches first is referred to as “upstream” and a position where the liquid reaches later is referred to as “downstream”. Further, in the present disclosure, “left” means left when viewed in a direction from upstream to downstream, and “right” means right when viewed in a direction from upstream to downstream.

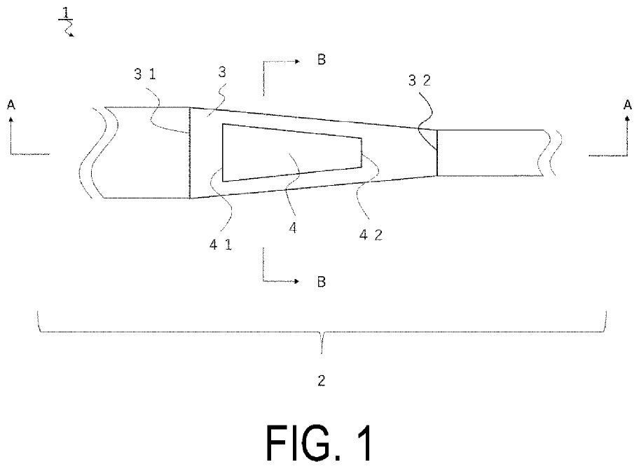

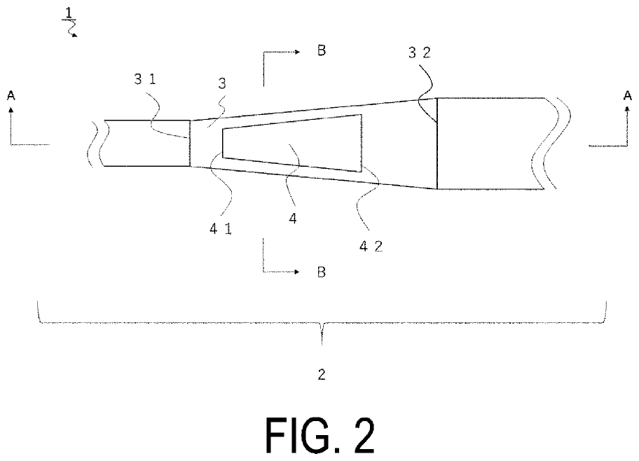

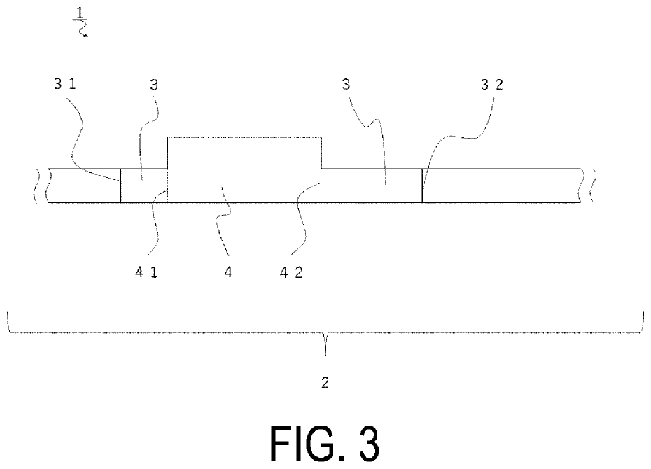

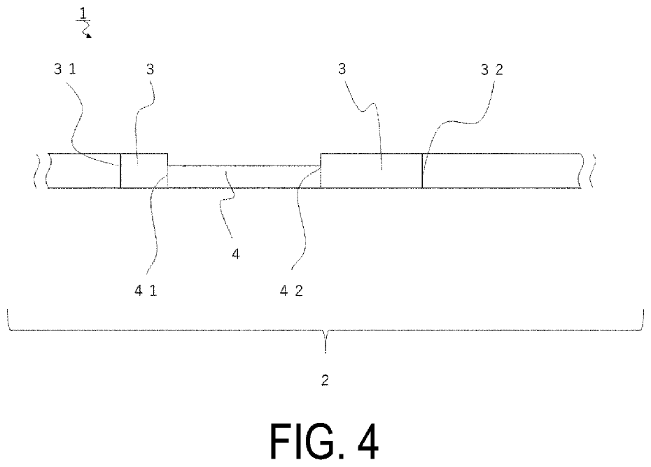

FIGS. 1 and 2 are top views of the channel device 1 according to an embodiment. Further, FIGS. 3 and 4B are cross-sectional views when the channel device 1 illustrated in FIGS. 1 and 2, respectively, is cut along a cut line A-A. Note that in these figures, a part of a channel 2 is omitted. The omitted part is indicated by wavy lines. That is, each of FIGS. 1, 2, 3, and 4 illustrates a part of the channel 2. That is, the channel 2 may, for example, extend further upstream or downstream than illustrated in these figures.

The channel device 1 includes the channel 2 through which a liquid flows. A side surface is formed in the channel 2 along a direction in which the liquid flows. That is, the direction in which the liquid flows is determined according to the shape of the side surface of the channel 2.

The channel 2 is formed of, for example, a resin. The channel 2 according to the embodiment is formed of a hydrophobic resin. Specifically, the channel 2 may be formed of, for example, a resin having a contact angle with water of 60 degrees or more. The contact angle with water of a material for forming the channel 2 may be obtained by, for example, a method for testing the wettability of a glass substrate (JIS R 3257: 1999). The resin is, for example, polycarbonate, cycloolefin polymer, a polymethyl methacrylate resin, or polydimethylsiloxane. The channel 2 according to the embodiment is formed of polymethyl methacrylate resin.

Note that the material for forming the channel 2 is not limited to these examples as long as the material can form the shape of the channel 2. The channel 2 may be formed of a material such as, glass, polydimethylsiloxane, polyester-based thermoplastic elastomer, polypropylene, or the like. Further, the channel 2 may be formed of, for example, any material, and an inner wall may be coated with a resin or an organic compound. The resin or organic compound for coating may be, for example, a resin having a contact angle with water of 60 degrees or more. Specifically, the resin for coating may be, for example, a fluororesin, a silicone resin, or a silane coupling agent.

The channel 2 may be a composite in which a plurality of members are combined. The channel 2 according to the embodiment is a composite in which the plurality of members are bonded together by an adhesive. Specifically, the channel 2 may be, for example, a composite in which a thin film is adhered to a formed substrate by an adhesive. The adhesive is, for example, a UV curable adhesive, a multifunctional epoxy crosslinked adhesive, or a silane coupling agent.

Note that the means for bonding the plurality of members together is not limited to an adhesive only. For example, an adhesive need not be used as long as the plurality of members can be structurally bonded together. Specifically, for example, each of a pair of members may be provided with a corresponding one of a protrusion and a hole fitted to the protrusion, and these may be fitted to each other to form the composite. Further, the plurality of members may all be made of the same material or may be made of different materials. The channel 2 according to the embodiment is a composite in which the plurality of members all made of the same material are combined. Furthermore, the channel 2 may be formed by known techniques such as injection molding.

In the embodiment, the channel 2 includes a first space 3 and a second space 4. The first space 3 and the second space 4 may be separated from each other via the channel 2 therebetween, and may be integrally connected to each other in a state where the channel 2 is not present therebetween. Specifically, the first space 3 includes a first inflow end 31 into which the liquid flows, and a first outflow end 32 from which the liquid flows out. Further, the second space 4 includes a second inflow end 41 into which the liquid flows, and a second outflow end 42 from which the liquid flows out. The second space 4 is located away from the first inflow end 31 and the first outflow end 32 of the first space 3. The second inflow end 41 and the second outflow end 42 of the second space 4 may be connected to the first space 3. That is, in the embodiment, the liquid flowing through the channel 2 may flow through the first space 3 closer to the upstream side to reach the second space 4, and may flow through the second space 4 to reach the first space 3 closer to the downstream side.

Note that a part in the channel 2 where the first space 3 and the second space 4 are located may be formed integrally with the other parts in the channel 2. That is, in the forming of the channel 2, the part where the first space 3 and the second space 4 are located and the other parts may be formed simultaneously. In this case, in the channel device 1 according to the embodiment, the part where the first space 3 and the second space 4 are located and the other parts are seamless, and thus liquid leakage can be prevented. Further, the part in the channel 2 where the first space 3 and the second space 4 are located may be formed separately from the other parts in the channel 2. That is, the channel 2 may be formed by bonding these parts each formed separately with an adhesive or the like. In this case, the user can easily assemble the channel 2 into any shape. That is, the channel device 1 according to the embodiment can improve convenience.

In the embodiment, the second space 4 is different in height from the first space 3. That is, the channel 2 may have a shape, for example, protruding upward when viewed from the side surface as illustrated in FIG. 3. Alternatively, the channel 2 may have a shape, for example, recessed at the top when viewed from the side surface as illustrated in FIG. 4. In other words, specifically, an upper end of the second space 4 may be located at a different height from an upper end of the first space 3. Further, lower ends of the first space 3 and the second space 4 may be located at the same height. Note that, in the present disclosure, “different heights” refers to different lengths in the vertical direction. Further, in the present disclosure, “located at a different height” means that the relative position is different in the vertical direction.

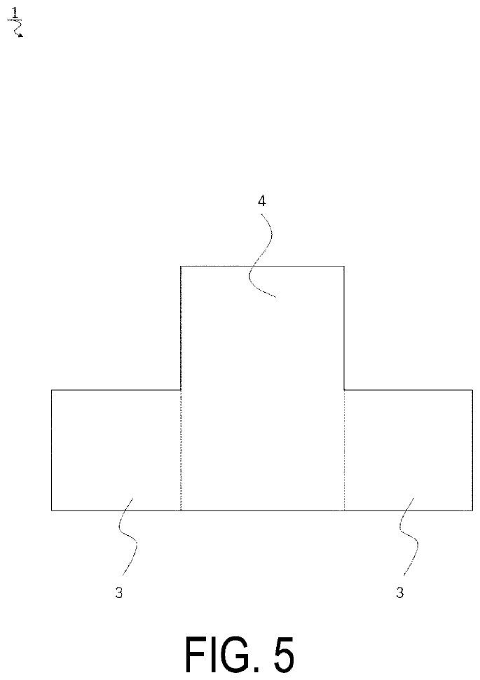

FIG. 5 is a cross-sectional view when the channel devices 1 illustrated in FIGS. 1 and 2 are cut along a cut line B-B. That is, FIG. 5 is an enlarged cross-sectional view illustrating a part in the channel 2 where both the first space 3 and the second space 4 are located.

Conventionally, in the channel device, air bubbles may be mixed in a liquid when the liquid flows through the channel. Specifically, in a case where the flow of the liquid flowing through the channel is non-uniform, the liquid may flow in a state where air bubbles are mixed in the liquid. For example, in a case where the liquid flows in a biased manner to either the left or right of the channel, or in a case where the liquid flows with a part of a tip surface of the liquid protruding, air bubbles are mixed in the flowing liquid as a result of entraining gas present downstream. In this case, the liquid volume delivered by the channel device is non-uniform. Further, in a case where the channel device is equipped with a sensor, the mixed air bubbles may cause erroneous detection. Thus, there is a need for a channel device that can control the flow of the liquid and reduce the risk of air bubbles being mixed in the liquid when the liquid flows through the channel.

In contrast, in the channel device 1 according to the present disclosure, at least a part of the first space 3 is located between the side surface of the channel 2 and at least a part of an outer periphery of the second space 4. That is, in the embodiment, the channel 2 includes a step in at least a part of the side surface. According to this configuration, the channel device 1 according to the embodiment can control the flow of the liquid, and thus the mixing of air bubbles can be reduced. Specifically, since the upper end of the second space 4 is located at a different height from the upper end of the first space 3, surface tension acts on the liquid at a boundary between the first space 3 and the second space 4. Thus, when the liquid flows from the first space 3 upstream to the second space 4, and when the liquid flows from the second space 4 to the first space 3 downstream, the traveling speed of the liquid is reduced. Further, the first space 3 is located between the side surface of the channel 2 and at least the part of the outer periphery of the second space 4, and thus a boundary surface between the first space 3 and the second space 4 can be increased. That is, the channel device 1 according to the embodiment can increase the surface tension acting on the liquid. As a result, the flow of the liquid flowing into the first space 3 is likely to be uniform at the boundary between the first space 3 and the second space 4. That is, the behavior of the interface of the liquid is likely to be uniform. Thus, the likelihood of air bubbles being mixed in the liquid flowing out from the first space 3 downstream is reduced.

Specifically, in the channel device 1 according to the present disclosure, the first space 3 may be located between the side surface of the channel 2 and all of the outer periphery of the second space 4. That is, the second space 4 may be surrounded by the first space 3 in plan view. As a result, when the liquid flows from the first space 3 upstream to the second space 4, and when the liquid flows from the second space 4 to the first space 3 downstream, the traveling speed of the liquid can be minimized. According to this, for example, even in the case of flow of a liquid that has a low viscosity and tends to travel relatively quickly, the mixing of air bubbles can be easily reduced.

In the embodiment, the upper end of the second space 4 is located at a position higher than the upper end of the first space 3. That is, the channel 2 may have, for example, a shape protruding upward when viewed from the side surface as illustrated in FIG. 1. Thus, when the liquid flows into the second space 4 from the first space 3, the liquid can travel in the upward direction. In this case, gravity or surface tension acts on the liquid, and thus the speed at which the liquid travels in the second space 4 can be decreased. Thus, the channel device 1 according to the embodiment can decrease the speed at which the liquid travels in the second space 4 when the liquid flows into the second space 4 from the first space 3. As a result, even in a case where, for example, the speed at which the liquid travels is likely to be relatively large, the channel device 1 can reduce the likelihood of air bubbles being mixed in the liquid. Further, in a case where air bubbles are contained in the liquid flowing into the first space 3, the second space 4 can trap the air bubbles. As a result, the channel device 1 can also reduce the likelihood of air bubbles flowing to the downstream side.

Note that, for example, in a case where the viscosity of the liquid is relatively small, or in a case where the bottom surface of the channel 2 is inclined downward from upstream to downstream, the speed at which the liquid travels is likely to be relatively large. However, the case where the configuration described above is applied to the channel device 1 is not limited to these examples.

The upper end of the second space 4 may be located at a position lower than the upper end of the first space 3. That is, the channel 2 may have, for example, a shape recessed at the top when viewed from the side surface as illustrated in FIG. 2. In this case, when the liquid flows into the second space 4 from the first space 3, the liquid can travel in the downward direction. Thus, gravity or surface tension acts on the liquid, and thus the speed at which the liquid travels in the second space 4 can be increased. As a result, even in a case where, for example, the speed at which the liquid travels is excessively small, the channel device 1 can reduce the likelihood of the liquid stopping in the channel 2. Further, even when, for example, the liquid has a high viscosity and it is difficult to make the liquid flow, the channel device 1 can facilitate the flow of the liquid to a predetermined position. Further, even in a case where, for example, the bottom surface of the channel 2 is inclined upward from upstream to downstream, the channel device 1 can facilitate the flow of the liquid to the predetermined position.

In the channel 2 according to the embodiment, the lower ends of the first space 3 and the second space 4 are located at the same height. In other words, for example, the lower end of the second space 4 may be connected to the lower end of the first space 3 as illustrated in FIGS. 1 and 2. That is, the first space 3 and the second space 4 may be located on the same plane. According to this, there is no projection, step or the like on the boundary surface of the lower ends of the first space 3 and the second space 4, and thus the flow of the liquid is less likely to be prevented. As a result, it is possible to reduce the likelihood of air bubbles being mixed in the liquid due to the liquid being disturbed when the liquid flows from the first space 3 into the second space 4. In the embodiment, the lower ends of the first space 3 and the second space 4 are located at the same height. That is, in the embodiment, the second space 4 is larger in height than the first space 3. Specifically, the first space 3 and the second space 4 may have a height ratio of, for example, 1:2.

Note that the relationship between the heights of the first space 3 and the second space 4 is not limited to the example described above. For example, the height of a part of the second space 4 may be smaller than the height of the first space 3. The entirety of the first space 3 and the second space 4 need not satisfy the ratio of the heights described above. For example, each of the heights of the first space 3 and the second space 4 need not be constant. That is, the ratio of the heights of some parts of each space need not satisfy 1:2. That is, the configuration of the channel 2 is not limited to the example described above as long as the likelihood of air bubbles being mixed in the liquid can be reduced.

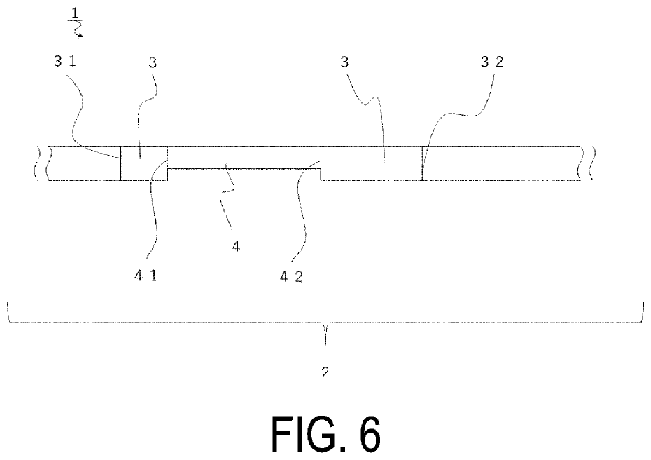

FIGS. 6, 7, 8, 9, 10, 11, 12, and 13 are cross-sectional views of when the channel device 1 including the channel 2 having yet another shape, is cut along the cut line A-A in FIGS. 1 and 2, similar to FIGS. 3 and 4.

The shape of the channel 2 is not limited to the examples described above. For example, the lower end of the second space 4 may be located at a different height from the lower end of the first space 3. Specifically, for example, the lower end of the second space 4 may be located above the lower end of the first space 3. That is, the channel 2 may have, for example, a shape recessed at the bottom when viewed from the side surface as illustrated in FIG. 6. In this case, the liquid can travel in the upward direction when flowing into the second space 4 from the first space 3 closer to the upstream side. Further, the liquid can travel in the downward direction when flowing out from the second space 4 to the first space 3 closer to the downstream side. Accordingly, the channel device 1 according to the embodiment can increase the speed at which the liquid travels when the liquid flows out from the second space 4 to the first space 3 while regulating the flow of the liquid when the liquid flows from the first space 3 into the second space 4. Thus, the channel device 1 according to the embodiment can relatively smoothly deliver the liquid to the channel 2 closer to the downstream side.

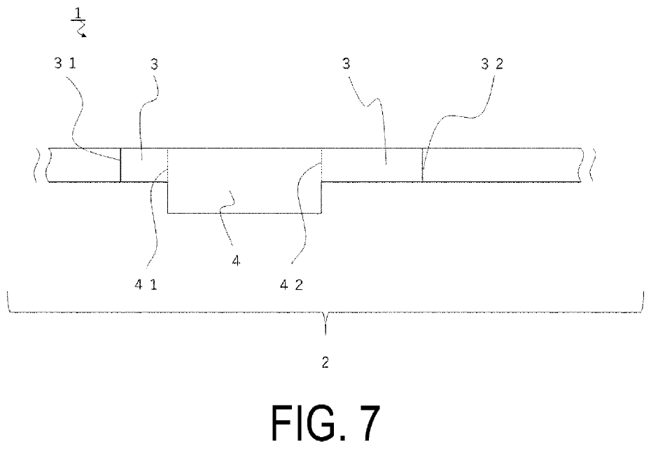

Further, for example, the lower end of the second space 4 may be located below the lower end of the first space 3. That is, the channel 2 may have, for example, a shape protruding downward when viewed from the side surface as illustrated in FIG. 7. In this case, the liquid can travel in the downward direction when flowing into the second space 4 from the first space 3 closer to the upstream side. Further, the liquid can travel in the upward direction when flowing out to the first space 3 closer to the downstream side from the second space 4. Thus, the channel device 1 according to the embodiment can regulate the flow of the liquid when flowing out from the second space 4 to the first space 4 closer to the downstream side while reducing the likelihood of the liquid stopping in the second space 4 when the liquid flows into the second space 4 from the first space 3 closer to the upstream side. Thus, the channel device 1 according to the embodiment can reduce the risk of air bubbles being mixed in the liquid while relatively smoothly delivering the liquid to the first space 3 closer to the downstream side.

The upper ends of the first space 3 and the second space 4 may be located at the same height. In other words, the upper end of the second space 4 may be connected to the upper end of the first space 3. That is, the upper ends of the first space 3 and the second space 4 may be located on the same plane. According to this, there is no projection, step or the like on the boundary surface of the upper ends of the first space 3 and the second space 4, and thus the flow of the liquid is less likely to be prevented. As a result, it is possible to reduce the likelihood of air bubbles being mixed in the liquid due to the liquid being disturbed when the liquid flows from the first space 3 into the second space 4.

Further, for example, the upper end of the second space 4 may be located at a different height from that of the upper end of the first space 3, and the lower end of the second space 4 may be located at a different height from the lower end of the first space 3.

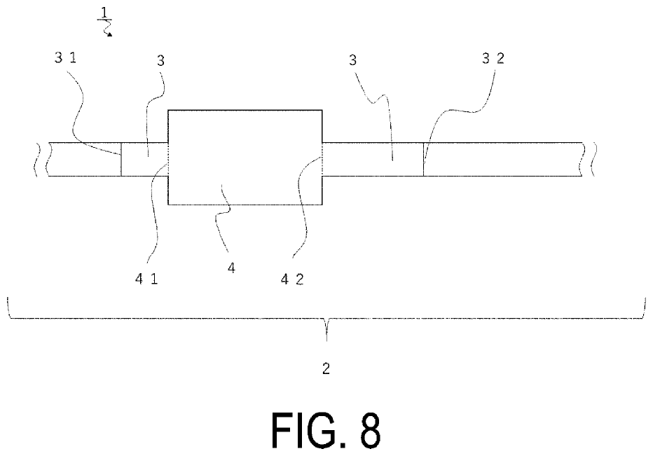

That is, the channel 2 may have, for example, a cross shape when viewed from the side surface as illustrated in FIG. 8. Here, in a case where air bubbles are mixed in the liquid, the air bubbles are trapped in a space closer to the upper end side protruding upward in the second space 4. In this case, the liquid can travel in the vertical direction when flowing into the second space 4 from the first space 3 closer to the upstream side. The gravity or surface tension acts on the liquid, and thus the liquid traveling in the downward direction travels faster than the liquid traveling in the upward direction. In other words, in the second space 4, the liquid is less likely to travel closer to the upper end side than closer to the lower end side. Thus, the channel device 1 according to the embodiment can easily hold the trapped air bubbles in the second space 4.

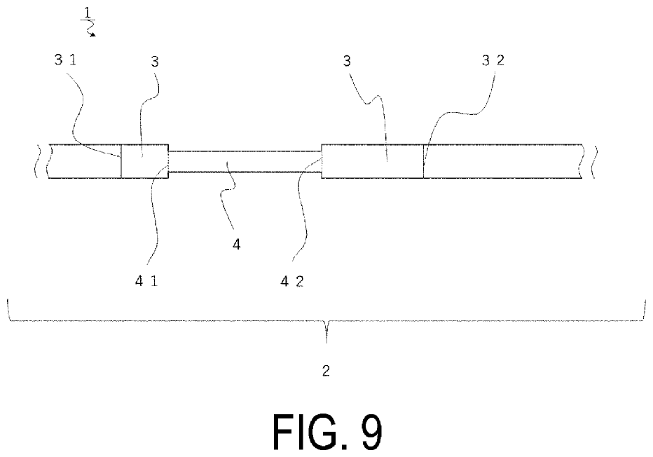

Further, the channel 2 may have, for example, an H shape as illustrated in FIG. 9. In this case, the upper end of the first space 3 closer to the upstream side is located at a position higher than the upper end of the second space 4. Thus, in a case where air bubbles are mixed in the liquid flowing into the first space 3 closer to the upstream side, the air bubbles are easily trapped in the first space 3 closer to the upstream side. Thus, the channel device 1 according to the embodiment can reduce the likelihood of air bubbles being mixed in the liquid flowing out from the channel 2 closer to the downstream side.

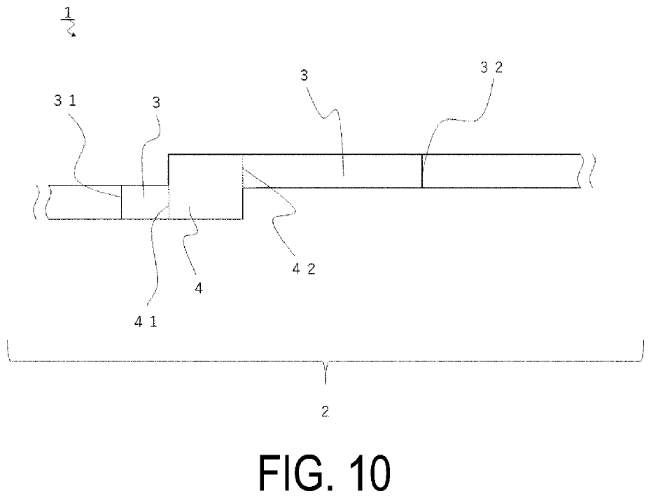

Further, for example, the upper end of the second space 4 may be located at a different height from that of the upper end of the first space 3 closer to the upstream side, and the lower end of the second space 4 may be located at a different height from the lower end of the first space closer to the downstream side. That is, the channel 2 may have, for example, an inverted Z shape when viewed from the side surface as illustrated in FIG. 10. In this case, the liquid can travel in the upward direction when flowing into the second space 4 from the first space 3 closer to the upstream side. Further, the liquid can also travel in the upward direction when flowing out from the second space 4 to the first space 3 closer to the downstream side. Thus, the channel device 1 according to the embodiment can further reduce the likelihood of air bubbles being mixed in the liquid.

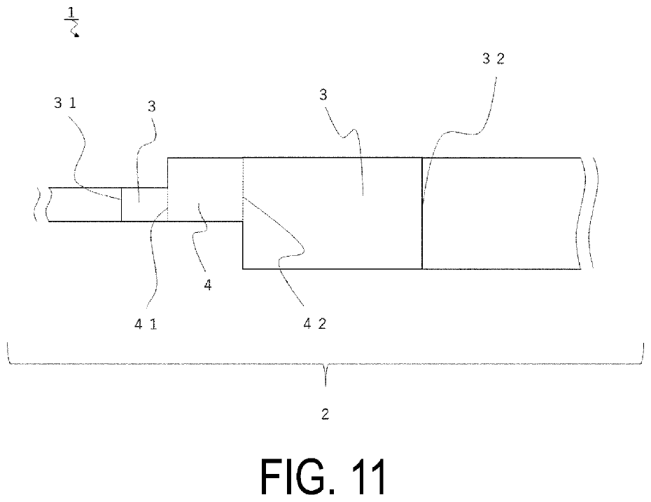

Further, the channel 2 may have a shape, for example, in which the height of the space increases from upstream to downstream as illustrated in FIG. 11. In this case, the liquid can travel in the upward direction when flowing into the second space 4 from the first space 3 closer to the upstream side. Further, the liquid can travel in the downward direction when flowing out from the second space 4 to the first space 3 closer to the downstream side. Accordingly, the channel device 1 according to the embodiment can increase the speed at which the liquid travels when the liquid flows out from the second space 4 to the first space 3 while regulating the flow of the liquid when the liquid flows from the first space 3 into the second space 4. Thus, the channel device 1 according to the embodiment can relatively smoothly deliver the liquid to the channel 2 closer to the downstream side.

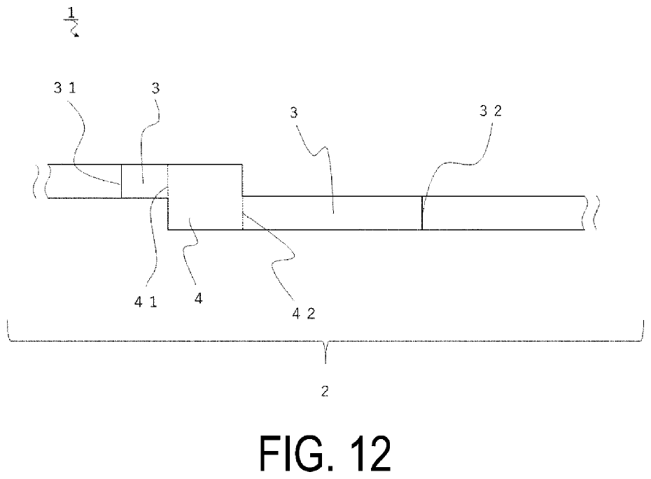

Further, for example, the upper end of the second space 4 may be located at a different height from that of the upper end of the first space 3 closer to the downstream side, and the lower end of the second space 4 may be located at a different height from the lower end of the first space closer to the upstream side. That is, the channel 2 may have, for example, a Z shape when viewed from the side surface as illustrated in FIG. 12. In this case, the liquid can travel in the downward direction when flowing into the second space 4 from the first space 3 closer to the upstream side. Further, the liquid can also travel in the downward direction when flowing out from the second space 4 to the first space 3 closer to the downstream side. Accordingly, the channel device 1 according to the embodiment can increase the speed at which the liquid flowing out to the first space 3 closer to the downstream side travels, while trapping air bubbles in the second space 4. That is, the channel device 1 according to the embodiment can relatively smoothly deliver the liquid to the channel 2 closer to the downstream side while reducing the risk of air bubbles being mixed in the liquid.

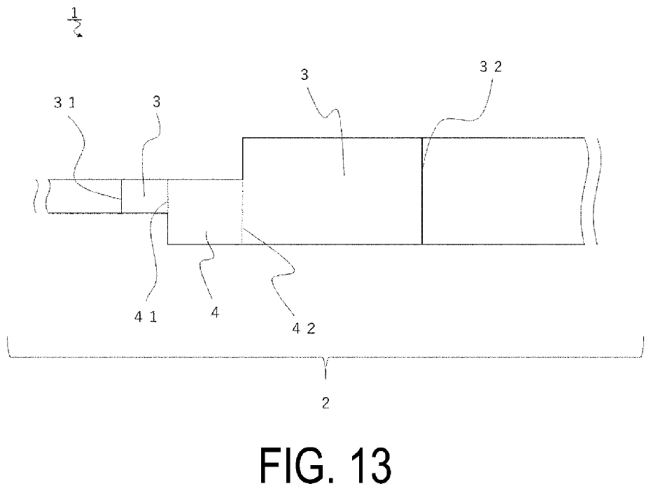

Further, the channel 2 may have, for example, a shape in which the height of the space decreases from upstream to downstream as illustrated in FIG. 13. In this case, the liquid can travel in the downward direction when flowing into the second space 4 from the first space 3 closer to the upstream side. Further, the liquid can travel in the upward direction when flowing out from the second space 4 to the first space 3 closer to the downstream side. Thus, the channel device 1 according to the embodiment can regulate the flow of the liquid when flowing out from the second space 4 to the first space 4 closer to the downstream side while reducing the likelihood of the liquid stopping in the second space 4 when the liquid flows into the second space 4 from the first space 3 closer to the upstream side. Thus, the channel device 1 according to the embodiment can reduce the risk of air bubbles being mixed in the liquid while relatively smoothly delivering the liquid to the first space 3 closer to the downstream side.

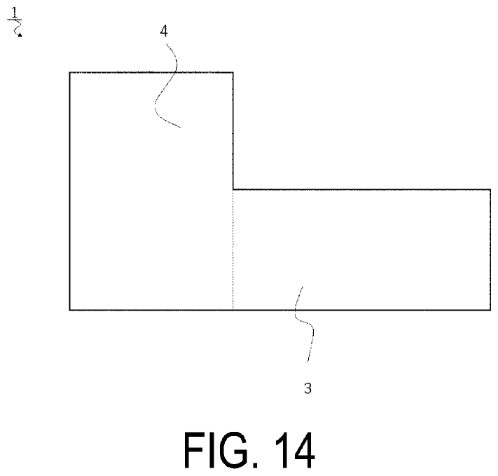

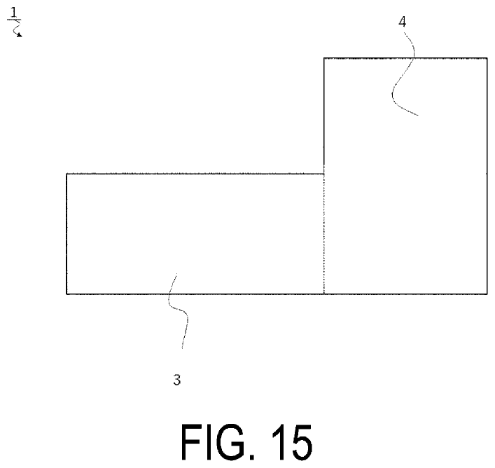

FIGS. 14 and 15 are cross-sectional views when the channel device 1 including the channel 2 having yet another shape, is cut along the cut line B-B in FIG. 1, similar to FIG. 5. In the channel 2 according to the embodiment, for example, the first space 3 may be located between either the left and right side surfaces of the channel 2 and the outer periphery of the second space 4 facing the side surface. In other words, as illustrated in FIGS. 14 and 15, a step may be located on either the left or right side of the channel 2. In this case, the liquid easily flows in a space having a smaller height, and thus the flow of the liquid can be biased to either the left or right of the channel 2. Thus, in a case where the liquid is likely to be biased to either the left or right of the channel 2, for example, in a case where the channel 2 has a shape curved to either the left or right, the flow of the liquid can be easily evenly aligned. That is, the channel device 1 according to the embodiment can reduce the likelihood of air bubbles being mixed in the liquid.

Note that positional relationships between the upper ends of the first space 3 and the second space 4 and between the lower ends of the first space 3 and the second space 4 are not limited to the examples described above. That is, the user may suitably employ, for example, any configuration that can reduce the likelihood of bubbles being mixed in the liquid other than the channel shapes illustrated in the above-described embodiments.

Here, in a case where the speed at which the liquid travels is excessively large, the flow of the liquid may be interrupted and air bubbles may be mixed in the liquid. Further, in a case where the speed at which the liquid travels is excessively small, the flow may stop due to surface tension or the like being applied in a direction opposite to the flow.

On the other hand, in the channel device 1 according to the present disclosure, widths in plan view are different between the first inflow end 31 and the first outflow end 32 of the first space 3. According to this, the channel device 1 according to the embodiment can adjust the speed of the liquid flowing out from the first space 3. That is, the amount of liquid located in the first space 3 can be adjusted.

In the embodiment, the width of the first inflow end 31 may be larger than the width of the first outflow end 32. In other words, a cross-sectional area in a direction orthogonal to a direction from the inflow to the outflow of the liquid may be larger at the first inflow end 31 than at the first outflow end 32. Specifically, the ratio of the widths of the first inflow end 31 and the first outflow end 32 may be 1:2. In this case, the speed at which the liquid flowing into the first space 3 travels can be made larger than the speed at which the liquid flowing out from the first space 3 travels. Thus, the flow of the liquid is less likely to be interrupted. That is, the likelihood of air bubbles being mixed in the liquid can be reduced.

The width of the first outflow end 32 may be larger than the width of the first inflow end 31. In other words, the cross-sectional area in a direction orthogonal to the direction from the inflow to the outflow of the liquid may be larger at the first outflow end 32 than at the first inflow end 31. Specifically, the ratio of the widths of the first inflow end 31 and the first outflow end 32 may be 2:1. In this case, the traveling speed of the liquid flowing out from the first space 3 can be made larger than the traveling speed of the liquid flowing into the first space 3. Thus, the likelihood of the flow stopping due to the decrease in the traveling speed can be reduced.

Thus, the channel device 1 according to the present disclosure can further control the flow of the liquid by combining the relationship between the heights of the first space 3 and the second space 4 and the relationship between the widths of the first inflow end 31 and the first outflow end 32 of the first space 3, described above.

The width of the channel 2 between the first inflow end 31 and the first outflow end 32 may change regularly. For example, the width of the channel 2 may become gradually smaller from the first inflow end 31 toward the first outflow end 32 as illustrated in FIG. 1. Alternatively, for example, the width of the channel 2 may be gradually larger from the first inflow end 31 toward the first outflow end 32 as illustrated in FIG. 2.

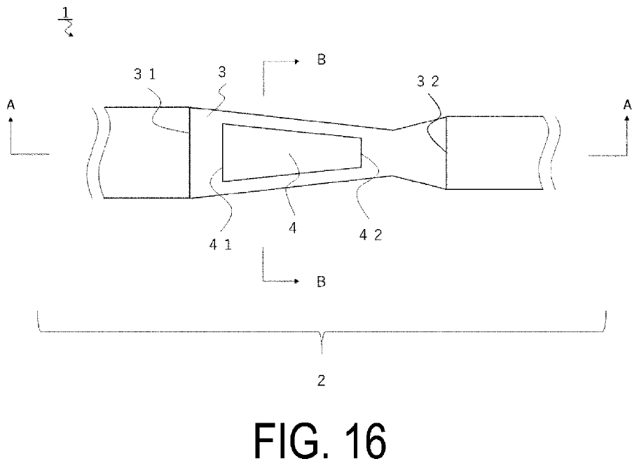

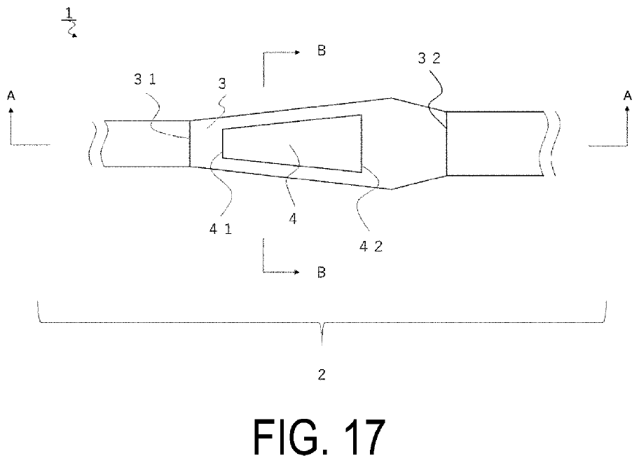

FIGS. 16 and 17 are top views illustrating shapes of yet other channels 2. For example, the width of the channel 2 may become gradually smaller from the first inflow end 31 toward the first outflow end 32 and then gradually larger as illustrated in FIG. 16. Further, for example, the width of the channel 2 may become gradually larger from the first inflow end 31 toward the first outflow end 32 and then gradually smaller as illustrated in FIG. 17. As a result, the channel device 1 can reduce the likelihood of air bubbles being mixed in the liquid due to the flow being disturbed and becoming non-uniform. In the channel device 1 according to the embodiment, the width of the channel 2 gradually decreases from the first inflow end 31 toward the first outflow end 32. Note that the relationship of the width of the channel 2 between the first inflow end 31 and the first outflow end 32 is not limited to the example described above as long as the mixing of air bubbles can be reduced. For example, the width of the channel 2 between the first inflow end 31 and the first outflow end 32 may change irregularly.

In the embodiment, the second inflow end 41 and the second outflow end 42 of the second space 4 have different widths in plan view. According to this, the channel device 1 according to the embodiment can adjust the traveling speed of the liquid flowing out from the second space 4. That is, the amount of liquid located in the second space 4 can be adjusted.

In the embodiment, the width of the second inflow end 41 is larger than the width of the second outflow end 42. In other words, the cross-sectional area in a direction orthogonal to the direction from the inflow to the outflow of the liquid may be larger at the second inflow end 41 than at the second outflow end 42. Specifically, the ratio of the widths of the second inflow end 41 and the second outflow end 42 may be 2:1. In this case, the traveling speed of the liquid flowing into the second space 4 can be made larger than the traveling speed of the liquid flowing out from the second space 4. Thus, the flow of the liquid is less likely to be interrupted. That is, the likelihood of air bubbles being mixed in the liquid can be reduced.

Further, the width of the second outflow end 42 may be larger than the width of the second inflow end 41. In other words, the cross-sectional area in the direction orthogonal to the direction from the inflow of the liquid to the outflow may be larger at the second outflow end 42 than at the second inflow end 41. Specifically, the ratio of the widths of the second inflow end 41 and the second outflow end 42 may be 1:2. In this case, the traveling speed of the liquid flowing out from the second space 4 can be made larger than the traveling speed of the liquid flowing into the second space 4. Thus, the likelihood of the flow stopping due to the decrease in the traveling speed can be reduced.

In the channel 2, a length from the second outflow end 42 of the second space 4 to the first outflow end 32 of the first space 3 may be longer than a length from the first inflow end 31 of the first space 3 to the second inflow end 41 of the second space 4. Specifically, the ratio of these lengths may be 1:2. According to this, it becomes easy to smoothly deliver the liquid downstream of the channel 2 while relatively shortening the length from the first inflow end 31 to the first outflow end 32 of the first space 3. Specifically, for example, in a case where the width of the channel 2 becomes narrower from upstream to downstream, the area of the channel 2 that is wetted by the liquid becomes smaller, and thus the traveling speed of the liquid becomes gradually larger. In this case, for example, by increasing the length from the second outflow end 42 to the first outflow end 32, the traveling speed of the liquid flowing downstream of the first space 3 can be increased while regulating the flow of the liquid. Thus, in a case where the liquid flows with relative difficulty, the liquid is easily delivered downstream of the first space 3 without stoppage of the flow of the liquid. Note that, for example, in a case where the viscosity of the liquid is relatively large, or in a case where the bottom surface of the channel 2 is inclined upward from upstream to downstream, the liquid flows with relative difficulty. However, the case where the configuration described above is applied to the channel device 1 is not limited to these examples.

Further, for example, in a case where the width of the channel 2 becomes wider from upstream to downstream, the area of the channel 2 that is wetted by the liquid becomes larger, and thus the traveling speed of the liquid becomes gradually smaller. In this case, for example, by increasing the length from the second outflow end 42 to the first outflow end 32, the traveling speed of the liquid flowing downstream of the first space 3 can be decreased while regulating the flow of the liquid. Thus, when the liquid flows with relative ease, the liquid is easily delivered downstream of the first space 3 without an excessive increase in the traveling speed of the liquid. That is, it becomes easy to reduce the likelihood of air bubbles being mixed in the liquid. Note that, for example, in a case where the viscosity of the liquid is relatively small, or in a case where the bottom surface of the channel 2 is inclined downward from upstream to downstream, the liquid flows with relative ease. However, the case where the configuration described above is applied to the channel device 1 is not limited to these examples.

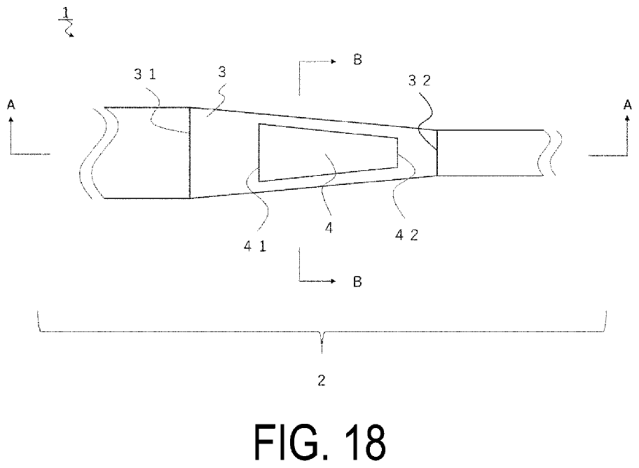

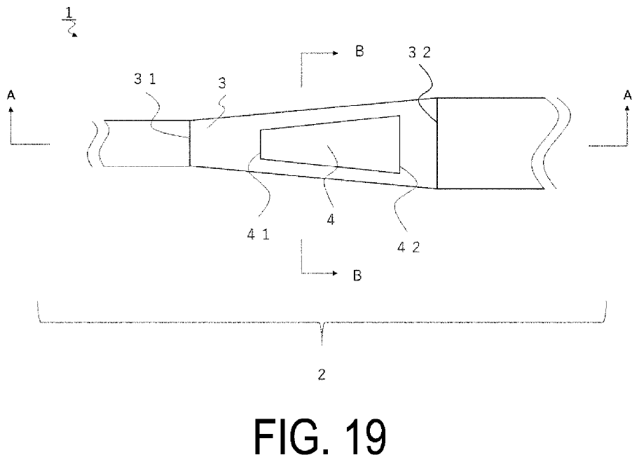

FIGS. 18 and 19 are top views of the appearance of the channel device 1 including the channel 2 having yet another shape. In the channel 2, a length from the first inflow end 31 of the first space 3 to the second inflow end 41 of the second space 4 may be longer than a length from the second outflow end 42 of the second space 4 to the first outflow end 32 of the first space 3. Specifically, the ratio of these lengths may be 2:1. According to this, it becomes easy to deliver the liquid flowing into the first space 3 to the second space 4 while relatively shortening the length from the first inflow end 31 to the first outflow end 32 of the first space 3. Specifically, for example, in a case where the width of the channel 2 becomes narrower from upstream to downstream, the area of the channel 2 that is wetted by the liquid becomes smaller, and thus the traveling speed of the liquid becomes gradually larger. In this case, for example, by increasing the length from the first inflow end 31 to the second inflow end 41, the traveling speed of the liquid flowing into the second space 4 can be increased while regulating the flow of the liquid. Thus, in a case where the liquid flows with relative difficulty, the liquid is easily delivered to the first space 3 closer to the downstream side without stoppage of the flow of the liquid in the second space 4.

Further, for example, in a case where the width of the channel 2 becomes wider from upstream to downstream, the area of the channel 2 that is wetted by the liquid becomes larger, and thus the traveling speed of the liquid becomes gradually smaller. In this case, for example, by increasing the length from the first inflow end 31 to the second inflow end 41, the traveling speed of the liquid flowing into the second space 4 can be decreased while regulating the flow of the liquid. Thus, in a case where the liquid flows with relative ease, the liquid is easily delivered to the second space 4 without an excessive increase in the traveling speed of the liquid.

### Other Embodiments

Note that the channel device 1 according to the present disclosure is not limited to the embodiment described above. That is, in the channel device 1 according to the present disclosure, in addition to the configurations described above, other configurations may be applied to the channel 2 of the above embodiment as appropriate.

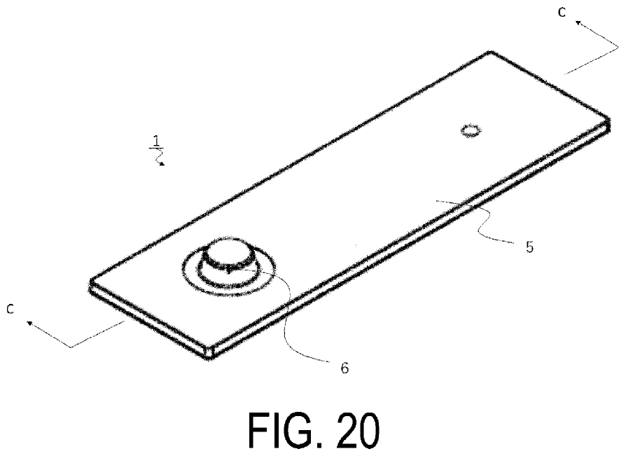

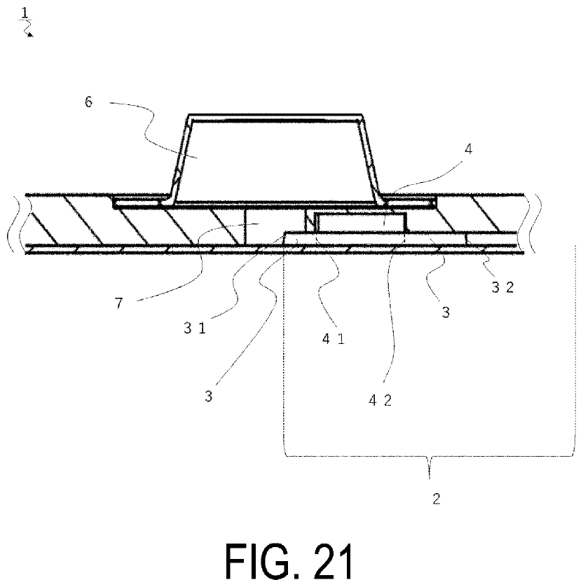

FIG. 20 is a perspective view of a channel device 1 according to another embodiment. FIG. 21 is a side cross-sectional view when the channel device 1 according to the other embodiment illustrated in FIG. 20 is cut along a cut line C-C. Note that in FIG. 21, a part of the channel 2 and a part of a channel substrate 5 described later are omitted. The omitted parts are indicated by wavy lines. That is, the channel 2 may extend further downstream than that, for example, illustrated in FIG. 21. Further, the channel substrate 5 may spread closer to the upstream side or the downstream side of the flow channel 2 than that, for example, illustrated in FIG. 21.

The channel device 1 according to another embodiment further includes the channel substrate 5. The channel substrate 5 can hold various members to be mounted on the channel device 1. Thus, for example, the channel 2 illustrated in the above embodiments may be located inside or outside the channel substrate 5. In the embodiment, the channel 2 is located inside the channel substrate 5.

The channel substrate 5 may be formed of, for example, a resin. Specifically, it may be formed of the same material as the channel 2 illustrated in the above-described embodiments. That is, the channel substrate 5 and the channel 2 may be formed integrally. In this case, the channel substrate 5 and the channel 2 need not be separately formed, and thus the process of forming the channel device 1 can be shortened. Note that the channel substrate 5 and the channel 2 may be formed by a known technique such as injection molding.

The channel device 1 according to the other embodiment may further include a holding portion 6 and a liquid receiving portion 7. The holding portion 6 can hold the liquid. The liquid receiving portion 7 can receive the liquid released from the holding portion 6.

The holding portion 6 and the liquid receiving portion 7 may be located, for example, outside or inside the channel substrate 5. In the embodiment, the holding portion 6 is located outside the channel substrate 5, and the liquid receiving portion 7 is located inside the channel substrate 5. Further, the liquid receiving portion 7 may open to an upper surface of the channel substrate 5 and connect with the channel 2. An opening of the liquid receiving portion 7 may be covered with a bottom surface of the holding portion 6. That is, in the embodiment, the liquid held in the holding portion 6 can flow into the liquid receiving portion 7 by the bottom surface of the holding portion 6 being opened, and further flow from the liquid receiving portion 7 into the channel 2.

The channel device 1 according to the other embodiment includes the holding portion 6, and thus the user need not introduce an appropriate amount of liquid to be used for each inspection into the channel 2. Thus, the channel device 1 according to the other embodiment can reduce the likelihood of an occurrence of an error due to a difference in handling by the user. Further, since the liquid can be stored in the holding portion 6, the user need not store the liquid in a separate container for the inspection. That is, the channel device 1 according to the other embodiment can improve convenience of inspection.

The holding portion 6 may be formed of any material depending on the type of liquid used for the inspection. For example, in a case where a liquid susceptible to oxidation is used, the holding portion 6 may be formed of a material having low oxygen permeability. For example, in a case where an acidic liquid is used, the holding portion 6 may be formed of an acid resistant material. Thus, the holding portion 6 may be formed of, for example, aluminum, polypropylene, or polyethylene. In the embodiment, the holding portion 6 is formed of polypropylene. Note that the holding portion 6 may be formed by a known technique such as casting.

The holding portion 6 is not limited to a specific shape as long as the holding portion 6 can hold the liquid. The holding portion 6 may be any shape, such as, for example, a frustum, such as a truncated cone, a truncated triangular cone, or a truncated square cone, a pyramid, such as a cone, a triangular pyramid, or a quadrangular pyramid, or a column, such as a cylinder, a triangular prism, or a quadrangular prism, or a combination thereof. In the embodiment, the holding portion 6 is a truncated cone. Note that an upper surface and a lower surface of the holding portion 6 need not necessarily be planar. At least one of the upper surface and the lower surface of the holding portion 6 may be, for example, a spherical surface having an apex at the top. In other words, for example, the holding portion 6 may have a so-called dome shape.

The liquid receiving portion 7 may be formed of, for example, a resin. Specifically, it may be formed of the same material as the channel 2 and the channel substrate 5 illustrated in the above-described embodiments. That is, the channel 2, the channel substrate 5, and the liquid receiving portion 7 may be formed integrally. In this case, they need not be separately formed, and thus the process of forming the channel device 1 can be shortened. Note that the liquid receiving portion 7 may be formed by a known technique such as injection molding, similar to the channel 2 and the channel substrate 5.

The liquid receiving portion 7 is not limited to a specific shape as long as the liquid receiving portion 7 can receive the liquid released from the holding portion 6. The liquid receiving portion 7 may be any shape, such as, for example, a frustum, such as a truncated cone, a truncated triangular cone, or a truncated square cone, a pyramid, such as a cone, a triangular pyramid, or a quadrangular pyramid, or a column, such as a cylinder, a triangular prism, or a quadrangular prism, or a combination thereof. In the embodiment, the liquid receiving portion 7 is a cylinder.

Next, a specific example will be described in which the first space 3 and the second space 4 are formed in the channel device 1 of the embodiment of the present disclosure.

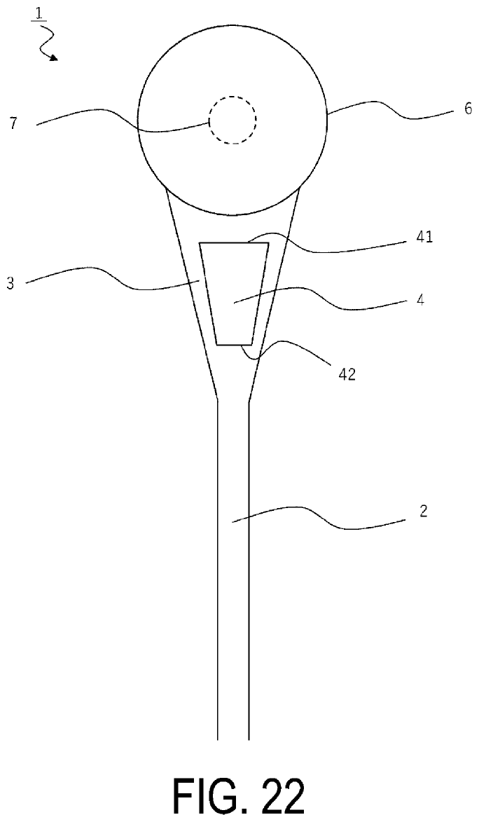

FIG. 22 is a view illustrating the periphery of the holding portion 6 in the channel device 1 according to the embodiment of the present disclosure. As illustrated in FIG. 22, in the channel device 1, the first space 3 and the second space 4 are formed in a position where a liquid injected into the liquid receiving portion 7 from the holding portion 6 is delivered from the liquid receiving portion 7 in the channel 2. In the channel device 1, the first space 3 and the second space 4 having the shapes illustrated in FIGS. 1 and 3 may be formed as illustrated in FIG. 22, or the first space 3 and the second space 4 having the shapes illustrated in FIG. 4, 6, 7, 8, 9, 10, 11, 12, or 13 may be formed. In the channel device 1, in a case where the first space 3 and the second space 4 having the shapes illustrated in FIGS. 1 and 3 are formed as illustrated in FIG. 22, the upper end of the second space 4 may be located at a position higher than the upper end of the first space 3.

With the configuration described above, surface tension acts on the liquid at the boundary between the first space 3 and the second space 4 when the liquid flows into the second space 4 from the first space 3, and thus the speed at which the liquid travels in the second space 4 can be decreased. Further, the first space 3 is located between the side surface of the channel 2 and at least the part of the outer periphery of the second space 4, and thus the boundary surface between the first space 3 and the second space 4 can be increased. That is, the channel device 1 according to the embodiment can increase the surface tension acting on the liquid. As a result, the flow of the liquid flowing into the first space 3 is likely to be uniform at the boundary between the first space 3 and the second space 4. That is, the behavior of the interface of the liquid is likely to be uniform. Thus, the likelihood of air bubbles being mixed in the liquid flowing out from the first space 3 downstream is reduced.

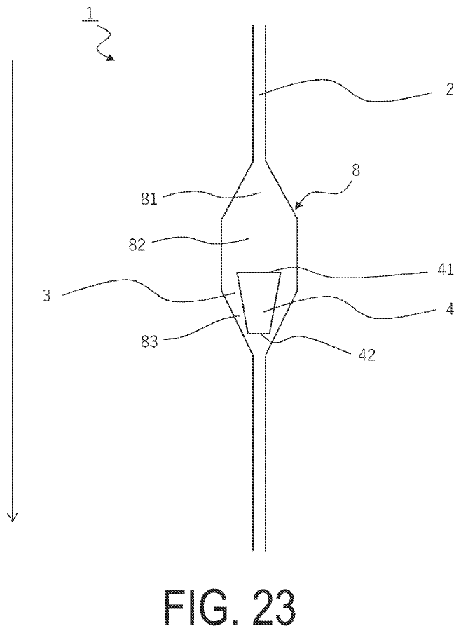

FIG. 23 is a view illustrating a configuration of a wide portion 8 included in a channel device 1 of the embodiment of the present disclosure. As illustrated in FIG. 23, the channel device 1 of the embodiment of the present disclosure may include the wide portion 8. The wide portion 8 constitutes a part of the channel 2, and has a structure in which the width of the channel is wider than the other parts in the channel 2. The wide portion 8A may be filled with a gas (for example, air). For example, in a case where another liquid is present downstream of the wide portion 8 in the channel 2, the air that fills the wide portion 8 is pushed downstream of the wide portion 8 as the liquid is delivered to the wide portion 8, and thus liquid that is present downstream of the wide portion 8 in the channel 2 can be delivered downstream. As a result, the liquid delivered to the wide portion 8 and the other liquid described above are in contact via the gas loaded in the wide portion 8, and thus the likelihood of the liquid delivered to the wide portion 8 and the other liquid being mixed with each other can be reduced. The maximum width of the channel in the wide portion 8 may be from 2.0 mm to 2.5 mm.

As illustrated in FIG. 23, the first space 3 and the second space 4 may be located in the wide portion 8. The wide portion 8 may include a first region 81 in which the width of the channel is gradually wider, a second region 82 in which the width of the channel is constant, and a third region 83 in which the width of the channel is gradually narrower, along a direction in which the liquid is delivered in the channel 2 (direction indicated by the arrow in FIG. 23). In this case, the first space 3 and the second space 4 may be located across the second region 82 and the third region 83. The first space 3 and the second space 4 located in the wide portion 8 may have the shapes illustrated in FIGS. 1 and 3, or the first space 3 and the second space 4 having the shapes illustrated in FIG. 4, 6, 7, 8, 9, 10, 11, 12, or 13 may be formed. In a case where the first space 3 and the second space 4 are located in the wide portion 8, the speed at which the liquid travels in the second space 4 can be decreased when the liquid flows through the wide portion 8. As a result, the likelihood of air bubbles being mixed in the liquid can be reduced, and the flow of the liquid can be regulated when the liquid flows from the first space 3 into the second space 4.

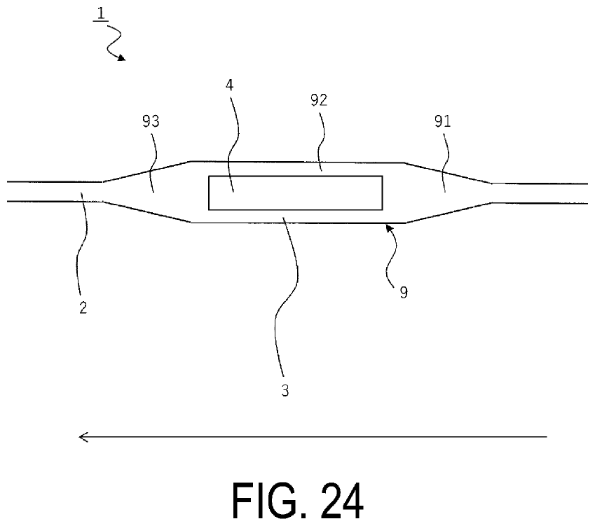

FIG. 24 is a view illustrating a configuration of a detection unit 9 included in a channel device 1 according to an embodiment of the present disclosure. The detection unit 9 is provided in the channel 2, and is a region for measuring a detection target substance contained in the liquid. The detection unit 9 in the present embodiment may include a sensor (not illustrated) for detecting an increase in weight due to an antigen contained in the liquid binding to an antibody pre-fixed to the detection unit 9.

The method for detecting the detection target substance in the detection unit 9 is not limited to the method described above. The detection method may be a method for measuring the intensity of fluorescence emitted by a fluorescent material directly or indirectly binding to the detection target substance, or a method for detecting the concentration of a product (such as a dye) directly or indirectly binding to the detection target substance.

As illustrated in FIG. 24, the detection unit 9 may include a fourth region 91 in which the width of the channel becomes gradually wider, a fifth region 92 in which the width of the channel is constant, and a sixth region 93 in which the width of the channel becomes gradually narrower, along a direction in which the liquid is delivered in the channel 2 (direction indicated by the arrow in FIG. 24). The first space 3 and the second space 4 may be located in the fifth region 92. In this case, the sensor may be located in the second space as illustrated in FIG. 24. The maximum width of the channel in the detection unit 9 may be from 1.0 mm to 1.5 mm.

According to the configuration described above, the speed at which the liquid travels in the second space 4 can be decreased when the liquid flows into the second space 4 (in other words, a place where the sensor is located) from the first space 3. As a result, in a case where the antibody is pre-fixed to the detection unit 9, the likelihood of the antigen contained in the liquid binding to the antibody pre-fixed to the detection unit 9 can be improved, and thus measurement accuracy can be improved.

Note that in the example illustrated in FIG. 24, one second space 4 is formed, but the channel device of the present disclosure is not limited thereto. The detection unit 9 may include two or more second spaces 4.

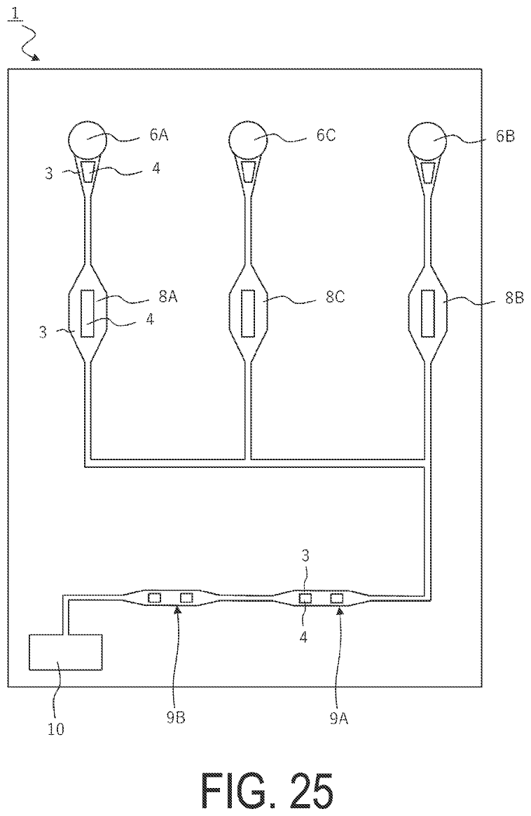

FIG. 25 is a view illustrating a configuration of a channel device 1 according to an embodiment of the present disclosure. As illustrated in FIG. 25, the channel device 1 may include a first holding portion 6A, a second holding portion 6B, a third holding portion 6C, a first wide portion 8A, a second wide portion 8B, a third wide portion 8C, a first detection unit 9A, a second detection unit 9B, and a waste liquid reservoir 10.

In the present embodiment, the first holding portion 6A holds a buffer solution, the second holding portion 6B holds an analyte solution, and the third holding portion 6C holds a buffer solution used for the purpose of washing off an antigen not bound to an antibody in the first detection unit 9A and the second detection unit 9B.

The first detection unit 9A and the second detection unit 9B may respectively measure different antigens contained in the analyte solution held in the second holding portion 6B, and the antibody need not be fixed to any one of the first detection unit 9A and the second detection unit 9B.

Next, a method for using the channel device 1 illustrated in FIG. 25 will be described. First, by opening a bottom surface of the first holding portion 6A, the buffer solution flows into the channel 2 from the first holding portion 6A. At this time, the first space 3 and the second space 4 are formed near the first holding portion 6A, and thus the likelihood of air bubbles being mixed in the buffer solution can be reduced. Further, in a case where air bubbles are contained in the buffer solution flowing into the first space 3, the air bubbles can be trapped by the second space 4. As a result, the likelihood of the air bubbles flowing closer to the downstream side can be reduced.

Next, the buffer solution passes through the first space 3 to reach the first wide portion 8A. The first wide portion 8A includes a configuration similar to that of the wide portion 8 described above. As a result, the flow of the buffer solution can be regulated when the buffer solution is delivered to the first wide portion 8A. The buffer solution having passed through the first wide portion 8A passes through the first detection unit 9A and the second detection unit, and is subsequently delivered to the waste liquid reservoir 10.

Next, by opening a bottom surface of the second waste liquid reservoir 6B, the analyte solution flows into the channel 2 from the second holding portion 6B to reach the second wide portion 8B. At this time, the gas loaded in the second wide portion 8B is sent downstream, and thus the buffer solution present in the channel 2 can be delivered downstream. As a result, the likelihood of the analyte solution and the buffer solution being mixed with each other can be reduced.

The analyte solution having passed through the second wide portion 8B flows into the first detection unit 9A. Since the first detection unit 9A includes the same configuration as the detection unit 9 described above, the likelihood of the antigen contained in the analyte solution binding to the antibody pre-fixed to the first detection unit 9A can be improved. As a result, the measurement accuracy can be improved.

The buffer solution flowing out from the first detection unit 9A then flows into the second detection unit 9B, and measurement of an antigen different from the antigen measured in the first detection unit 9A is performed. The buffer solution flowing out from the second detection unit 9B is delivered to the waste liquid reservoir 10.

Next, by opening a bottom surface of the third waste liquid reservoir 6B, the buffer solution flows into the channel 2 from the first holding portion 6A, passes through the third wide portion 8C, and flows into the first detection unit 9A and the second detection unit 9B. The antigen not binding to the antibody in the first detection unit 9A and the second detection unit 9B is washed off by the buffer solution guided to the first detection unit 9A and the second detection unit 9B. Thereafter the buffer solution is delivered to the waste liquid reservoir 10.

The embodiments of the channel device 1 according to the present disclosure have been described above based on the drawings and examples. However, it should be noted that those skilled in the art can easily make various variations or modifications based on the present disclosure. Thus, it should be noted that these variations or modifications are within the scope of the present disclosure. For example, it should be noted that the functions and the like included in the components and the like can be repositioned, provided that logical inconsistencies are avoided, and a plurality of the components and the like can be combined into one or divided.

For example, in FIG. 1, each of the first inflow end 31 and the first outflow end 32 of the first space 3, and the second inflow end 41 and the second outflow end 42 of the second space 4 is indicated by a straight line, but is not limited thereto. For example, the first inflow end 31 and the first outflow end 32 of the first space 3, and the second inflow end 41 and the second outflow end 42 of the second space 4 may be curved lines including vertices closer to the upstream side or downstream side of the channel 2.

For example, in the embodiment described above, the holding portion 6 is located on the upper surface of the channel substrate 5, but may be located on the lower surface. In this case, the liquid receiving portion 7 may open to the lower surface of the channel substrate 5.

In the present disclosure, descriptions of “first”, “second”, and the like are identifiers for distinguishing the configurations of the channel device 1 according to the embodiment. Configurations distinguished by the terms “first”, “second”, and the like in the present disclosure can exchange the numbers in the configurations with each other. For example, the first space 3 and the second space 4 can exchange the identifiers “first” and “second” with each other. The identifiers are interchanged simultaneously. The configurations are distinguished even after the identifiers are interchanged. The identifiers may be deleted. Configurations with identifiers deleted are distinguished by reference signs. No interpretation on the order of the configurations shall be given based solely on the description of identifiers such as “first” and “second” in the present disclosure. Further in the present disclosure, “traveling speed” may be interpreted as a flow rate or a flow velocity. The flow rate refers to the amount of liquid flowing per unit time. The flow velocity refers to the distance the liquid travels per unit time.

### REFERENCE SIGNS LIST

1 Channel device
2 Channel
3 First space
31 First inflow end
32 First outflow end
4 Second space
41 Second inflow end
42 Second outflow end
5 Channel substrate
6 Holding portion
61 Protruding portion
61a First surface
7 Liquid receiving portion

1. A channel device comprising:
a channel comprising a side surface along a direction in which a liquid flows;
a first space located in the channel;
a second space located to be in contact with the first space in the channel, an upper end being located at a different height from an upper end of the first space,
wherein at least a part of the first space is located between the side surface of the channel and at least a part of an outer periphery of the second space.

2. The channel device according to claim 1, wherein the upper end of the second space is located at a position higher than the upper end of the first space.

3. The channel device according to claim 2, wherein the second space is larger in height than the first space.

4. The channel device according to claim 1, wherein the upper end of the second space is located at a position lower than the upper end of the first space.

5. The channel device according to claim 4, wherein the second space is smaller in height than the first space.

6. The channel device according to claim 1, wherein a lower end of the second space is located at the same plane as a lower end of the first space.

7. The channel device according to claim 1, wherein the lower end of the second space is located at a position lower than the lower end of the first space.

8. The channel device according to claim 1, wherein
the first space comprises a first inflow end, the liquid flowing into the first inflow end, and a first outflow end, the liquid flowing out from the first outflow end, and
the first inflow end is larger in width than the first outflow end.

9. The channel device according to claim 1, wherein
the first space comprises a first inflow end, the liquid flowing into the first inflow end, and a first outflow end, the liquid flowing out from the first outflow end, and
the first inflow end is smaller in width than the first outflow end.

10. The channel device according to claim 1, wherein
the second space comprises a second inflow end, the liquid flowing into the second inflow end, and a second outflow end, the liquid flowing out from the second outflow end, and
the second inflow end is larger in width than the second outflow end.

11. The channel device according to claim 1, wherein
the second space comprises a second inflow end, the liquid flowing into the second inflow end, and a second outflow end, the liquid flowing out from the second outflow end, and
the second inflow end is smaller in width than the second outflow end.

12. The channel device according to claim 1, wherein in the first space, a length from the first inflow end to the second inflow end is longer than a length from the second outflow end to the first outflow end.

13. The channel device according to claim 1, wherein in the first space, a length from the first inflow end to the second inflow end is shorter than a length from the second outflow end to the first outflow end.

14. The channel device according to claim 1, further comprising:
a channel substrate located in the channel;
a holding portion located on an upper surface of the channel substrate and being capable of holding the liquid; and
a liquid receiving portion opening to the upper surface of the channel substrate and connecting to the channel, wherein
an opening of the liquid receiving portion is covered by a bottom surface of the holding portion.

15. The channel device according to claim 14, wherein the holding portion comprises a first surface facing the upper surface of the channel substrate and a protruding portion located on an outer edge of the first surface and protruding upward.

16. The channel device according to claim 15, wherein at least a part of the first surface is in contact with a liquid surface of the liquid loaded in the holding portion.

17. The channel device according to claim 1, wherein the channel is formed of a hydrophobic material.

18. The channel device according to claim 1, wherein an inner peripheral surface of the channel is coated with a hydrophobic material.
